(19) United States
(12) Patent Application Publication
(10) Pub. No.: US 2003/0081758 A1
(43) Pub. Date: May 1, 2003

(54) Method of and apparatus for automatically dialing a telephone number received from a personal digital assistant

(75) Inventors: Saket Kumar, Sunnyvale, CA (US); Li Qiaoyun, Cupertino, CA (US)

Correspondence Address: Jonthan O. Owens, HAVERSTOCK & OWENS LLP, 260 Sheridan Avenue, Suite 402, Palo Alto, CA, 94306, US

(73) Assignee: Sony Electronics, Inc.

(21) Appl. No.: 10/003,888

(22) Filed: Oct. 25, 2001

(51) Int. Cl. H04M 1/00; H04M 3/00

(52) U.S. Cl. 379/355.03; 379/355.1

(57) ABSTRACT

This invention enables personal digital assistants to quickly and accurately transmit stored telephone numbers directly to an integrated telephone or other communication device containing a dialing device. The preferred embodiment of this invention links the personal digital assistant directly to a compatible communication device. Then the personal digital assistant transmits data and instructions preferably via a wireless connection directly to the telephone, wherein the telephone automatically stores and dials the transmitted phone number. In an alternative embodiment of the present invention, the PDA transmits stored telephone numbers to an external dialing device, wherein the external dialing device transmits the information to a compatible telephone or other communication device and instructs the telephone to automatically dial the transmitted telephone numbers. This external dialing device is linked to both the personal digital assistant and a communication device and is capable of automatically transmitting, receiving, storing, and dialing telephone numbers transmitted from the personal digital assistant. The preferred wireless manner to transfer the data is infra-red. In alternative embodiments, the data transfer can be conducted via a wired, wireless, or other connection.

### FIELD OF THE INVENTION

The present invention relates to a method and apparatus for dialing a telephone number.

More particularly, the present invention relates to receiving a telephone number transferred from a personal digital assistant at a communication device.

### BACKGROUND OF THE INVENTION

One of the most important innovations of the modem century is the telephone. It is certain that no other technology will replace the telephone in the near future. Thus, utilizing the telephone to adapt toward more user friendly applications is in the best interest of the public. Modem telephones have many features including, but not limited to, storing telephone numbers, dialing stored telephone numbers within the telephone's memory, re-dialing, call forwarding, call transferring, and video capabilities.

While many advances have been made in modem telephone sets, there are still some limitations. These limitations include the inability to hold numerous telephone numbers and the inability to receive, analyze, and utilize telephone numbers from other sources, such as a personal digital assistant (PDA).

Due to the limitation in the ability to transfer data between PDAs and telephone sets, there is a loss in productivity and convenience enjoyed in modem life. For instance, a user having multiple telephone numbers in her PDA must manually enter the individual telephone numbers one at a time into the telephone set.

PDAs can, amongst other things, store addresses and phone numbers. The communication that takes place between two PDAs is typically through an infra-red beam. The communication that takes place between a PDA and a computer is typically done through cable via a serial or USB port on the PDA. Some PDAs also offer other wireless methods to transfer data including the Bluetooth Tm short range radio system. Finally, some PDAs offer telephone modem accessories to transfer files.

### SUMMARY OF THE INVENTION

This invention enables personal digital assistants to quickly and accurately transmit stored telephone numbers directly to an integrated telephone or other communication device containing a dialing device. The preferred embodiment of this invention links the personal digital assistant directly to a compatible communication device. Then the personal digital assistant transmits data and instructions preferably via a wireless connection directly to the telephone, wherein the telephone automatically stores and dials the transmitted phone number. In an alternative embodiment of the present invention, the PDA transmits stored telephone numbers to an external dialing device, wherein the external dialing device transmits the information to a compatible telephone or other communication device and instructs the telephone to automatically dial the transmitted telephone numbers. This external dialing device is linked to both the personal digital assistant and a communication device and is capable of automatically transmitting, receiving, storing, and dialing telephone numbers transmitted from the personal digital assistant. The preferred wireless manner to transfer the data is infra-red. In alternative embodiments, the data transfer can be conducted via a wired, wireless, or other connection.

Other features and advantages of the present invention will become apparent after reviewing the detailed description of the preferred embodiments set forth below.

### BRIEF DESCRIPTION OF THE DRAWINGS

FIG. 1A illustrates a block diagram schematic of the preferred system for dialing a telephone number between a personal digital assistant capable of wireless infra-red transmission of data and a communication device containing an integrated dialing device.

FIG. 1B illustrates a block diagram schematic of an alternative system for dialing a telephone number between a personal digital assistant capable of wireless infra-red transmission of data, an external dialing device and a communication device.

FIG. 2 illustrates a block diagram schematic of a personal digital assistant capable of wireless infra-red transmission of data.

FIG. 3 illustrates a block diagram schematic of the preferred embodiment of the present invention detailing the components within a communication device including an integrated dialing device.

FIG. 4 illustrates a block diagram schematic of an alternate embodiment of the present invention detailing the components within a stand-alone dialing device external from a communication device.

FIG. 5 illustrates a flow diagram of the steps involved in automatically dialing a telephone number transferred from a PDA to a communication device with an integrated dialing device according to the preferred embodiment of the present invention.

### DETAILED DESCRIPTION OF THE PREFERRED EMBODIMENT

To make the best use of a personal digital assistant's (PDA's) capability to store data, the preferred embodiment of the present invention allows the transfer of data from a PDA to a communication device such as a telephone set. This is accomplished by a method and apparatus used to transmit and automatically manipulate (dial, reject, store, etc.) a telephone number that has been transmitted to a communication device from a PDA.

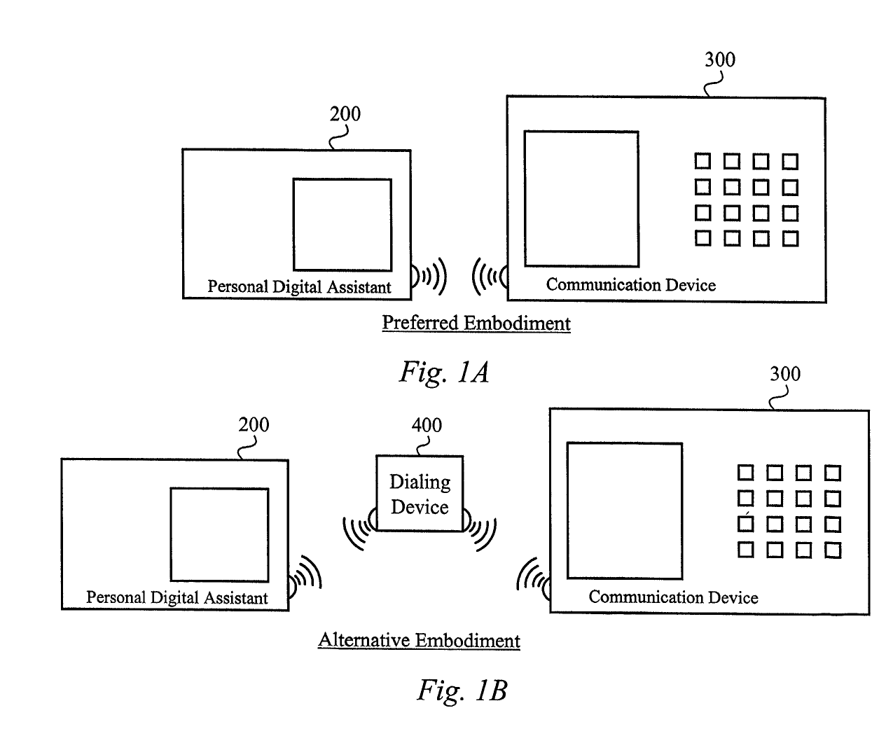

This invention enables personal digital assistants to quickly and accurately transmit stored telephone numbers to a telephone set, and alternatively to other dialing devices, wherein the telephone set or the dialing devices automatically dial the transmitted telephone number. As shown in FIG. 1, the preferred embodiment of this invention enables a personal digital assistant 200 to transmit, via a wireless connection, stored data and instructions directly to a communication device 300, wherein the communication device 300 with an integrated dialing device automatically stores and dials the transmitted telephone number.

In an alternative embodiment also shown in FIG. 1, an external dialing device 400 is linked to both a personal digital assistant 200 and a communication device 300. This external dialing device 400 automatically receives, stores, and transmits telephone numbers from the personal digital assistant 200 to the communication device 300 and automatically dials the transferred telephone numbers.

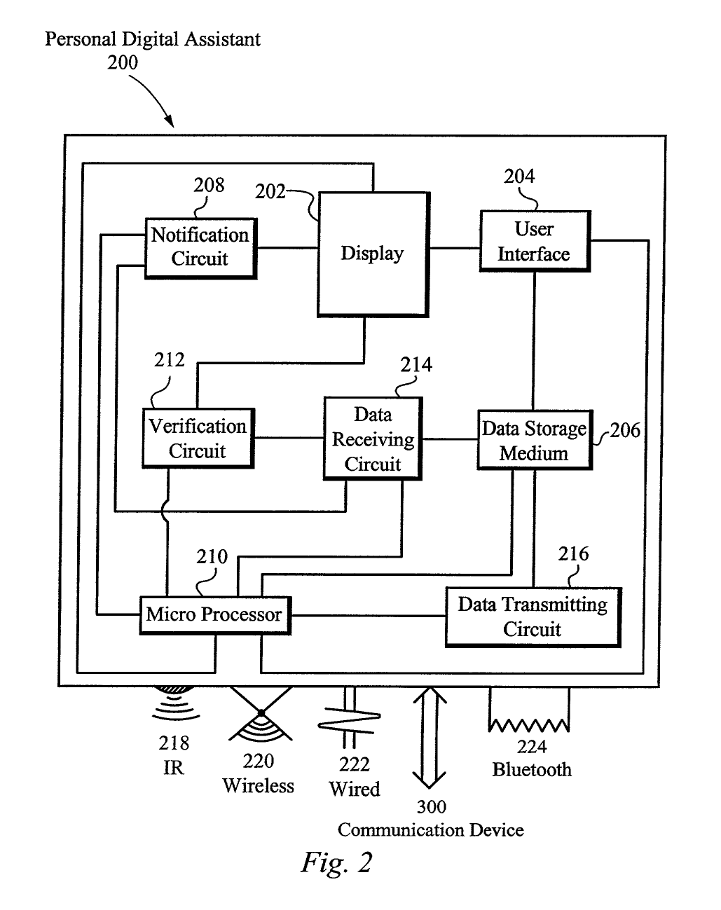

FIG. 2 illustrates a block diagram schematic of the components within a personal digital assistant 200 (PDA) of the preferred embodiment of the present invention. The personal digital assistant 200 stores various types of data. This data includes, but is not limited to, names, telephone numbers, and email addresses. Typically, a user of a personal digital assistant views data on a display 202 and inputs data via a user interface 204. The display 202 is usually a small liquid crystal display (LCD) and the user interface 204 is a miniature keyboard or stylus/touch-screen incorporating technology and handwriting recognition programs used for data entry. The data input by the user is stored in a data storage medium 206. The display 202 is coupled to the user interface 204, the notification circuit 208, the microprocessor 210, and the verification circuit 212. The user interface 204 is coupled to the display 202, the data storage medium 206, and the microprocessor 210.

Like standard desktop and laptop computers, PDAs are powered by a microprocessor 210. The microprocessor 210 coordinates all of the PDA's functions according to programmed instructions. Unlike Personal Computers, PDAs generally use smaller and cheaper microprocessors. Typical PDA microprocessors include Motorola Dragonball, Multiprocessor without Interlocked Pipeline Stages (MIPS), or Hitachi's SH7709a. The microprocessor 210 is coupled to the display 202, the user interface 204, the data storage medium 206, the notification circuit 208, the verification circuit 212, the data receiving circuit 214, and the data transmitting circuit 216.

The microprocessor 210 follows pre-programmed instructions contained within the operating system. PDAs typically have one of two types of operating systems, Palm OS (3Com) or PocketPC (formerly called Windows CE, Microsoft). Other companies are developing software for both operating systems.

The personal digital assistant 200 has capabilities to transmit data to another PDA or computer via the wireless connections 218 and 220, wired 222 connections, Bluetooth™ connection 224 and any other appropriate available connection technology. The data transmitting capability is represented by the data transmitting circuit 216 shown in FIG. 2. The preferred connection utilized by the data transmitting circuit 216 is the wireless infra-red connection 218. Alternatively, any other appropriate and available wireless connection 220, wired connection 222, Bluetooth™ connection 224 or other connections may be used.

The data from the personal digital assistant 200 is transmitted via the data transmitting circuit 216. The data transmitting circuit 216 consists of a means for transmitting data preferably through the wireless infra-red connection 218 or alternatively through a wireless connection 220, wired connection 222, Bluetooth™ connection 224 or other connection. The data transmitting circuit 216 is coupled to the data storage medium 206 and the microprocessor 210. This data storage medium 206 contains user inputted data which includes, but is not limited to telephone numbers, names, and addresses. In addition, the data storage medium 206 contains user inputted instructions providing specific instructions on what actions to take with the inputted and transmitted data.

To properly transmit data and instructions preferably to a communication device 300, or alternatively to the external dialing device 400, the personal digital assistant 200 first verifies that a connection has been established prior to transmitting. This is conducted by a verification circuit 212 which is coupled to the display 202, the microprocessor 210, and the data receiving circuit 218 found within the personal digital assistant 200. The verification circuit 212 detects whether or not a connection has been successfully made between the personal digital assistant 200 and the communication device 300. After the verification circuit 212 has verified that a connection has been made, the notification circuit 208 then provides the user a status of the connection and transmission through the display 202. The notification circuit 208 is coupled to the display 202, the microprocessor 210, and the data receiving circuit 218 and is capable of receiving an error message from the communication device 300, or alternatively, the external dialing device 400. The error message informs the user that the connection or transmission between the personal digital assistant 200 and the communication device 300 or the external dialing device 400 was unsuccessful. In addition, this notification circuit 208 is capable of receiving a status message from the external dialing device 400 or the communication device 300 informing the user that the connection and transmission was successful by way of the data receiving circuit 218.

Even with the personal digital assistant's 200 capabilities to transmit data, currently there is no mechanism for a personal digital assistant 200 to transmit telephone numbers directly to a communication device 300 that will then automatically store or dial the transmitted data.

The preferred embodiment of the current invention allows the user to transmit data and a series of instructions stored within the data storage medium 206 of the personal digital assistant 200 directly to a compatible communication device 300. This communication device 300 preferably includes an integrated dialing device internally. In an alternate embodiment of the present invention, the data and instructions are transmitted from the personal digital assistant 200 to an external dialing device 400 which in turn transmits the data and instructions to a compatible communication device 300.

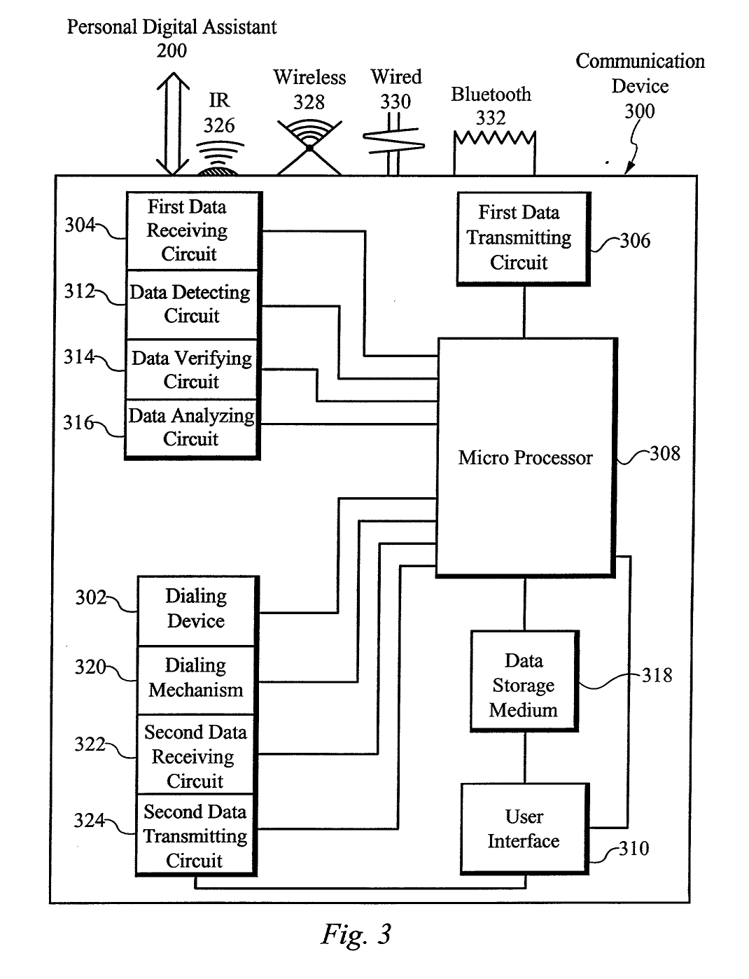

FIG. 3 illustrates a block diagram schematic of the components within the communication device 300 of the preferred embodiment of the present invention. The preferred embodiment of the present invention is a communication device 300 which includes an integrated dialing device 302. The internal dialing device 302 of the communication device 300 allows data from a personal digital assistant 200 to be automatically transferred, stored, and dialed by the communication device 300 with minimal time and effort. The internal dialing device 302 is coupled to the microprocessor 308, the dialing mechanism 320, the second data receiving circuit 322, and the second data transmitting circuit 324.

The preferred communication device 300 shown is a telephone. However, in alternate embodiments, the communication device 300 may be a mobile or cellular phone, a two-way pager, video phone, or any other similar communication device.

There are various means for the communication device 300 to link, communicate, and transfer data from and to the personal digital assistant 200. The first data receiving circuit 304 and the first data transmitting circuit 306 of the preferred embodiment of the present invention preferably use an infra-red connection 326 for data transmission between the communication device 300 and the personal digital assistant 200. In alternate embodiments of the present invention, the connection and data transmission by the first data receiving circuit 304 and data transmitting circuit 306 between the communication device 300 and the personal digital assistant 200 can be conducted via a wireless connection 328, a wired connection 330, a Bluetooth™ connection 332, or any other appropriate and available connections. The first data transmitting circuit 306 is coupled to the microprocessor 308. The first data receiving circuit 304 is coupled to the microprocessor 308, the first data detecting circuit 312, the data verifying circuit 314, and the data analyzing circuit 316.

The communication device 300 is powered by a microprocessor 308. The microprocessor 308 coordinates all of the functions of the communication device 300. The microprocessor 308 is coupled to the internal dialing device 302, first data receiving circuit 304, the first data transmitting circuit 306, the user interface 310, the data detecting circuit 312, the data verifying circuit 314, the data analyzing circuit 316, the data storage medium 318, the dialing mechanism 320, the second data receiving circuit 322, and the second data transmitting circuit 324.

The communication device 300 also consists of a user interface 310 that is utilized by the user to dial telephone numbers, to answer telephone calls from other compatible communication devices, and to check on the status of a transmission, transfer, or communication. The user interface 310 is coupled to the microprocessor 308 and the second data transmitting circuit 324. It should be noted that the user interface 310 may easily integrate a LCD or similar display which allows the user a visual output of what actions are taking place as well as status and error messages.

The first data receiving circuit 304 is used to detect, verify, and analyze data transfers from a personal digital assistant 200. The first data receiving circuit 304 is an integration of and coupled to the data detecting circuit 312, the data verifying circuit 314, and the data analyzing circuit 316. In addition, the first data receiving circuit 304 is coupled to the microprocessor 308. It should be noted, however, that the first data receiving circuit 304, the data detecting circuit 312, the data verifying circuit 314, and the data analyzing circuit 316 could alternatively be separate components contained within the communication device 300.

The data detecting circuit 312 is used to detect a request for use of the communication device 300. Once the data detecting circuit 312 is triggered, the communication device 300 must verify whether a successful connection has been made. The data detecting circuit 312 is coupled to the first data receiving circuit 304, the microprocessor 308, the data verifying circuit 314, and the first data analyzing circuit 316.

Following detection of a request for use of the communication device 300 and prior to receiving data from the personal digital assistant 200, the data verification circuit 314 verifies that successful connections have been made between the communication device 300 and the personal digital assistant 200. The status of the connection is relayed to the microprocessor 308 and a status message regarding the connections is in turn relayed to the user. This status message is transmitted to the personal digital assistant 200 via the first data transmitting circuit 306. The data verification circuit 314 is coupled to the microprocessor 308, the first data receiving circuit 304, the data detecting circuit 312, and the data analyzing circuit 316.

Once a successful connection is verified between the personal digital assistant 200 and the communication device 300, the data analyzing circuit 316 determines whether the transmitted data is of a compatible type. The data analyzing circuit 316 serves to eliminate either user or transmission errors. The first data analyzing circuit 316 is coupled to the microprocessor 308, the first data receiving circuit 304, the data detecting circuit 312, and the data verification circuit 314.

If the data is of a useable type, the data is transferred from the personal digital assistant 200 to the communication device 300 via the first data receiving circuit 304. The first data receiving circuit 304 receives data from the personal digital assistant 200. Following linking to the personal digital assistant 200 for data transfer, the first data receiving circuit 304 then proceeds to transfer the data received from the personal digital assistant 200 to the internal dialing device 302. Data is transferred to the internal dialing device 302 from the first data receiving circuit 304 via the second data receiving circuit 322. The second data receiving circuit 322 is coupled to the internal dialing device 302, the microprocessor 308, the user interface 310, the dialing mechanism 320, and the second data transmitting circuit 324.

Once the data is transferred from the personal digital assistant 200 to the first data receiving device 304 and from the data receiving device 304 to the internal dialing device 302, the transferred data is stored temporarily or permanently within the data storage medium 318. The data storage medium 318 is capable of storing data that includes, but is not limited to, telephone numbers, names, and addresses. The data storage medium 318 is coupled to the microprocessor 308, and the user interface 310.

Next, the dialing mechanism 320 found within the internal dialing device 302 commences to dial out the transferred telephone number received from the personal digital assistant 200. To dial the transmitted number, the dialing mechanism 320 converts the telephone number data to the corresponding distinctive touch tone keypad numeric dial-tone. The dialing mechanism 320 is coupled to the dialing device 302, the microprocessor 308, the second data receiving circuit 322, and the second data transmitting circuit 324. The dialing mechanism 320, by way of the second data transmitting circuit 324, triggers a dial-tone from the communication device 300 and automatically dials the telephone number data transferred from the personal digital assistant 200. The second data transmitting circuit 324 is coupled to the dialing device 302, the microprocessor 308, the dialing mechanism 320, and the second data receiving circuit 322.

In addition to triggering a dial-tone from the communication device 300, the second data transmitting circuit 324 communicates with the microprocessor 308 and provides the status of the data transfer or communication.

If the loop is completed, the user will be able to speak into the communication device 300 in a normal manner. If the dialed number is busy, a busy tone will be returned to the internal dialing device 302. The internal dialing device 302 then informs the communication device 300 of the busy signal and the communication device 300 will thereby inform the personal digital assistant 200 of the busy signal via the first data transmitting circuit 306, the second data transmitting circuit 324 and the user interface 310.

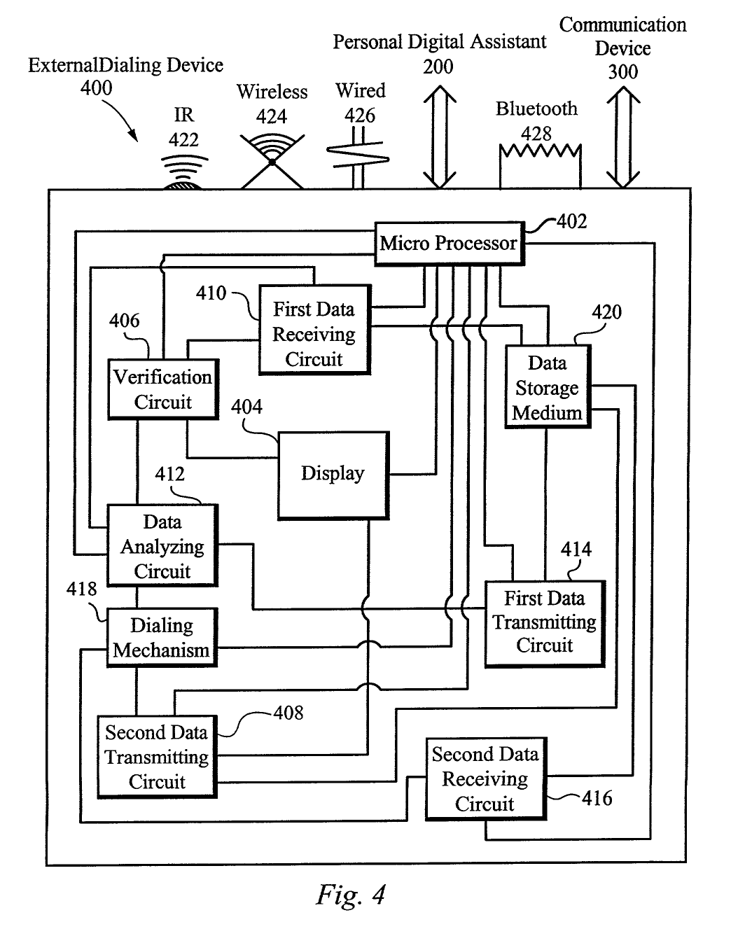

FIG. 4 illustrates a block diagram schematic of the components of an external dialing device 400 of an alternative embodiment of the present invention. The external dialing device 400 is a stand-alone device that links with a personal digital assistant 200 and a communication device 300. Once a connection is made between the external dialing device 400, the personal digital assistant 200, and the communication device 300, the external dialing device 400 allows the user to automatically transfer, store, and dial out telephone numbers stored within the personal digital assistant 200 with minimal effort, memorization, and time.

The external dialing device 400 is powered by a microprocessor 402. The microprocessor coordinates all of the functions of the external dialing device 400. The microprocessor 402 is coupled to the display 404, the verification circuit 406, the second data transmitting circuit 408, the first data receiving circuit 410, the data analyzing circuit 412, the first data transmitting circuit 414, the second data receiving circuit 416, the dialing mechanism 418, and the data storage medium 420.

The external dialing device 400 preferably has a display 404 which allows the user to see what actions are taking place as well as to receive status and error messages. This display 404 is coupled to the microprocessor 402, the verification circuit 406 and the second data transmitting circuit 408.

Prior to receiving data from the personal digital assistant 200, the verification circuit 406 of the external dialing device 400 verifies that successful connections have been made. The verification circuit 406 is coupled to the microprocessor 402, the display 404, the first data receiving circuit 410 and the data analyzing circuit 412. The verification circuit 406 verifies that successful connections have been made between the external dialing device 400 and external sources including the communication device 300 and the personal digital assistant 200. A status message regarding the connections is in turn relayed to the user. This status message is transmitted by the verification circuit 406 to the personal digital assistant 200 via the first data transmitting circuit 414. The first data transmitting circuit 414 is coupled to the microprocessor 402, the data analyzing circuit 412, the data storage medium 420,

The first data receiving circuit 410 receives data from the personal digital assistant 200 following a successful connection. The first data receiving circuit 410 links the personal digital assistant 200 and the external dialing device 400 to each other for data transfer and communication. The first data receiving circuit 410 is coupled to the microprocessor 402, the verification circuit 406, the data analyzing circuit 412, and the data storage medium 420.

The external dialing device 400 also contains a second data receiving circuit 416 which receives data from the communication device 300 and informs the external dialing device 400 of the status of the connection between the external dialing device 400 and the communication device 300. The second data receiving circuit 416 is coupled to the microprocessor 402, the dialing mechanism 418 and the data storage medium 420.

The first data transmitting circuit 414 provides a means for the external dialing device 400 to transmit data to the communication device 300. The first data transmitting circuit 414 is coupled to the microprocessor 402, the data analyzing circuit 412 as well as the data storage medium 420. There are various means for the personal digital assistant 200 and the external dialing device 400 to link, communicate, and transfer data to one another. The preferred embodiment of the present invention utilizes the infra-red connection 422 to transmit data to and receive data from the personal digital assistant 200. In other embodiments of the present invention, the connection and data transmission between devices can be conducted via wireless connection 424, wired connection 426, Bluetooth Tm connection 428, or any other appropriate means of connection.

The data storage medium 420 is capable of storing data that includes, but is not limited to, telephone numbers, names, and addresses. The data storage medium 420 is coupled to the microprocessor 402, the second data transmitting circuit 408, the first data receiving circuit 410, the first data transmitting circuit 414, and the second data receiving circuit 416.

The data analyzing circuit 412 determines whether the transmitted data is of a compatible type. Upon receiving the data and instructions from the personal digital assistant 200, the data analyzing circuit 412 analyzes the transmitted data to verify that the data can be used by the communication device 300. The data analyzing circuit 412 is coupled to the microprocessor 402, the verification circuit 406, the first data receiving circuit 410, the first data transmitting circuit 414, and the dialing mechanism 418. If there is an error in the data transmission or the data type, the external dialing device 400, by way of the first data transmitting circuit 414 sends an error message to the personal digital assistant 200. If the data transmission is successful and the data type is acceptable, the external dialing device 400, by way of the first data transmitting circuit 414 sends a successful status message to the personal digital assistant 200. The external dialing device 400 then stores the transferred data in the data storage medium 420 and commences to transmit data and instructions to the communication device 300.

Following successful transfer of data and instructions between the personal digital assistant 200 and the external dialing device 400, the external dialing device 400 commences to store the transferred data temporarily or permanently within the data storage medium 420. The external dialing device 400 uses the first data transmitting circuit 414 to communicate with the personal digital assistant 200 as well as the data storage medium 420, and the data analyzing circuit 412. Next, the external dialing device 400 converts the transferred data to unique dial-tones by utilizing the dialing mechanism 418. The dialing mechanism 418 is coupled to the microprocessor 402, the second data transmitting circuit 408, the data analyzing circuit 412, and the second data receiving circuit 416.

The dialing mechanism 418, by way of the second data transmitting circuit 408, transmits data and instructions to the communication device 300. The second data transmitting circuit 408 is coupled to the microprocessor 402, the display 404, the dialing mechanism 418, and the data storage medium 420. The dialing mechanism 418 converts the telephone number data to the corresponding distinctive touch tone keypad numeric dial-tone. In addition, the dialing mechanism 418, by way of the second data transmitting circuit 408, triggers a dial-tone from the communication device 300 and automatically dials the telephone number data transferred from the personal digital assistant 200.

The unique dial-tone data and instructions are transmitted by the external dialing device 400 to the communication device 300 by way of the second data transmitting circuit 408. The second data receiving circuit 416 communicates with the communication device 300 and informs the external dialing device 400 of the status of the data transfer or communication between the external dialing device 400 and the communication device 300.

There are various ways for the external dialing device 400 to link, communicate, and transfer data and instructions to the communication device 300. The preferred embodiment of the present invention involves the use of the infra-red connection 422 for data transmission and reception between the external dialing device 400 and the communication device 300. In alternate embodiments of the present invention, the connection and data transmission between the external dialing device 400 and the communication device 300 can be conducted via a wireless connection 424, a wired connection 426, a Bluetooth™ connection 428, or any other appropriate and available means of connection.

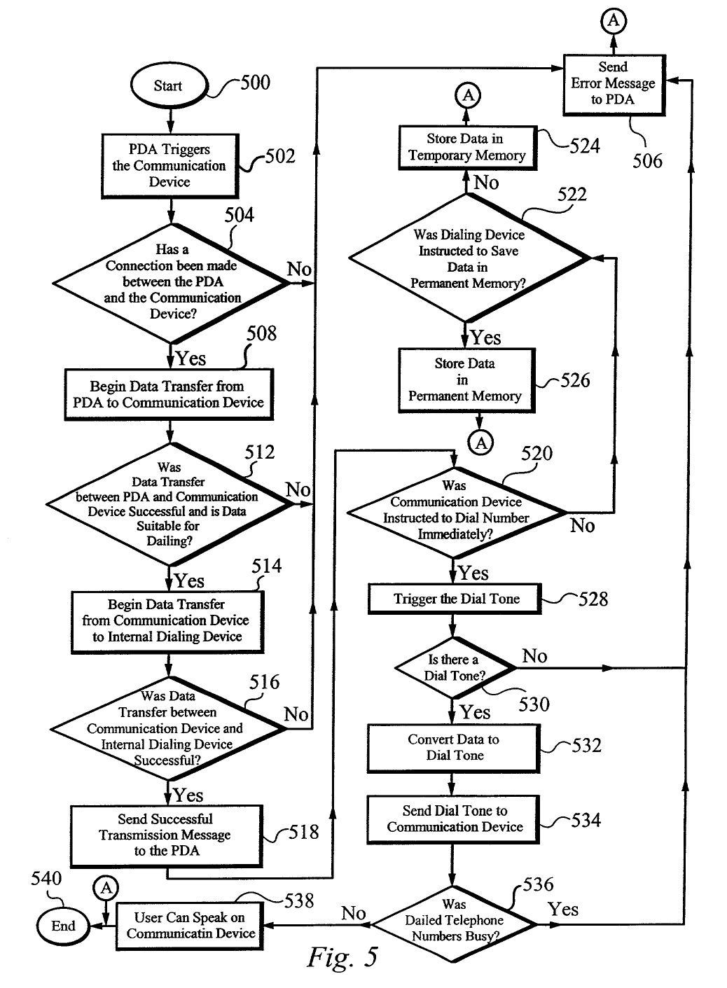

FIG. 5 shows a schematic flowchart illustrating the preferred embodiment of the present invention. In the preferred embodiment of the present invention, a personal digital assistant 200 transmits telephone numbers, data, and instructions to a communication device 300, whereby the communication device 300 automatically stores and dials the transmitted telephone number.

Step 500 starts the process in which the personal digital assistant 200 transmits a telephone number to a communication device 300. The communication device 300 thereby automatically dials the telephone number.

Step 500 commences when the personal digital assistant 200 user starts the data transfer process between the personal digital assistant 200 and the communication device 300. Alternatively, the data transfer process may be conducted between the personal digital assistant 200 and an external dialing device 400, as described above. As described previously, the data and instructions are transmitted between the various devices via infra-red, wired, wireless, Bluetooth™, or other means of connection.

First, in the step 502, the communication device 300 is triggered by the personal digital assistant 200. Next, in the step 504, it is determined whether a connection has been made between the personal digital assistant 200 and the communication device 300. If no connection has been made, or if there were errors in the actual transmission or in the type of data transferred, in the step 506 the communication device 300 sends an error message to the personal digital assistant 200. For example, the step 506 error message may inform the user of a time out error if the data transmission is unsuccessful within a predetermined (user defined) period of time, or may inform the user if the data was not of the type suitable for dialing.

If in the step 504 the connection is successful between the personal digital assistant 200 and the communication device 300 then, in the step 508 of the preferred embodiment of the present invention, the personal digital assistant 200 begins the data transfer to the communication device 300. Alternatively, the personal digital assistant 200 may transmit the data and instructions directly to a compatible external dialing device 400 if all connections between the devices are successful. The communication device 300 will analyze the transferred data in step 510 to determine if the data is suitable for dialing. If the data is numeric, the communication device 300 verifies the number of digits of the received data. For example, the received telephone number may be a local United States telephone number (7 digits), a long distance United States number (10 or 11 digits), a United States toll free number (10 digits), an international number (more than 20 digits), a number with * or or time interval pauses (e.g. to check voicemail).

Following the data analysis in the step 510, it is then determined in the step 512 whether the data transfer between the personal digital assistant 200 and the communication device 300 was successful and whether the transferred data is suitable for dialing. If the data transfer between the personal digital assistant 200 and the communication device 300 was not successful, then a step 506 error message is sent to the personal digital assistant 200. If the data transfer between the personal digital assistant 200 and the communication device 300 was successful, then the communication device 300, in the step 514, begins data transfer from the communication device 300 to the internal dialing device 302. In the step 516, it is determined whether the data transfer between the communication device 300 and the internal dialing device 302 was successful. If this second data transfer is unsuccessful, a step 506 error message is sent to the personal digital assistant 200. If it is determined at the step 516 that the second data transfer was successful, the communication device 300 will then send a successful data transmission message to the personal digital assistant 200 at the step 518.

After sending a successful data transmission message, the dialing device 500 next follows the instructions received from the personal digital assistant 200. In the step 520, the communication device 300 determines whether it was instructed to dial the transmitted telephone number immediately. If the communication device 300 was not instructed to immediately dial the transmitted telephone number, then in the step 522, the communication device 300 determines whether to save the telephone number in permanent memory. It should be noted that in an alternative embodiment, the external dialing device 400 may be instructed to dial the telephone number at a later time.

If it is determined at the step 522 that the communication device 300 was not instructed to save the telephone number in permanent memory, then at the step 524, the telephone number is stored in temporary memory. The process then ends at the step 540. Otherwise, if it is determined at the step 522 that the communication device 300 was instructed to save the telephone number in permanent memory, then at the step 526 the telephone number is stored in the permanent memory. The process then ends at the step 540.

If it is determined at the at the step 520 that the communication device 300 was instructed to immediately dial the telephone number received from the personal digital assistant 200, then the communication device 300 triggers an electronic switch dial-tone in the step 528.

In the step 530, the communication device 300 then determines whether there is a dial-tone. If it is determined at the step 530 that there is no dial-tone, a step 506 error message is sent to the personal digital assistant 200. If it is determined at the step 530 that there is a dial-tone, the communication device 300, in the step 532, converts the received telephone number data to the corresponding distinctive touch tone keypad numeric dial-tones. In the step 534, these unique dial-tones are then sent to the dialing mechanism 320 by the internal dialing device 302 thereby enabling automatic dialing of the received number. In the step 536, it is determined if the dialed telephone is busy. If it is determined at the step 536 that the dialed number is busy, a busy tone will be returned from the communication device 300 to the internal dialing device 302 and a step 506 error message will be then returned from the communication device 300 to the personal digital assistant 200. Otherwise, if it is determined at the step 536 that the dialed number was not busy and the call is going through, the user is then able to speak in the step 538 on the communication device 300 in a normal manner. The process then ends at the step 540.

A typical PDA is equipped with over one megabyte of memory. Since one megabyte of memory can store thousands of telephone numbers, there is a need to make the best use of a PDAs capability to store data. Currently, the transfer of data between a personal digital assistant and a communication device such as a telephone is not possible. The preferred embodiment of the present invention describes a system for transmitting, receiving, and dialing a telephone number from a personal digital assistant to a communication device. The preferred system allows data transmission and reception between a personal digital assistant that is capable of wireless infra-red transmission of data and a communication device containing an integrated dialing device. In an alternative system for dialing a telephone number, the personal digital assistant capable of wireless infra-red transmission of data transfers data to an external dialing device which thereby transfers this data to the communication device.

By allowing the transfer of the stored PDA data to existing and future telephone sets, a user will be able to take full advantage of the data storage capabilities of the modem personal digital assistant device. The ability to transfer data between personal digital assistants and communication devices will reduce the time, effort, and error associated with manually dialing telephone numbers on a communication device.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

What is claimed is:

1. A method of dialing a telephone number comprising:
a. transmitting data from a personal digital assistant device to a communication device, wherein the data includes the telephone number; and
b. automatically dialing the telephone number by a dialing device.

2. The method as claimed in claim 1 wherein the dialing device is integral to the communication device.

3. The method as claimed in claim 1 wherein the dialing device is an external device linked to the communication device.

4. The method as claimed in claim 1 further comprising verifying that a connection has been established between the personal digital assistant device and the communication device.

5. The method as claimed in claim 1 further comprising analyzing compatibility of transferred data.

6. The method as claimed in claim 1 further comprising sending a status message to the personal digital assistant device regarding status of data transmission.

7. The method as claimed in claim 1 further comprising storing the data within a dialing device memory.

8. The method as claimed in claim 1 further comprising storing the data within a communication device memory.

9. A method of dialing a telephone number comprising:
a. transmitting data from a personal digital assistant device to a dialing device, wherein the data includes the telephone number; and
b. transmitting the data from the dialing device to a communication device, wherein the telephone number is automatically dialed by the communication device.

10. The method as claimed in claim 9 further comprising saving the telephone number in a dialing device memory.

11. A system for dialing a telephone number comprising:
a. a personal digital assistant device for transmitting data including the telephone number;
b. a dialing device capable of reception and transmission of data; and
c. a communication device coupled to the dialing device for reception of the data transmitted from the dialing device.

12. The system as claimed in claim 11 wherein the dialing device is external to the communication device.

13. The system as claimed in claim 11 wherein the dialing device is integrated within the communication device.

14. A personal digital assistant device for automatically dialing a telephone number via a communication device comprising:
a. a data communications circuit for transferring data including the telephone number to a communication device and receiving data from an external source;
b. a verification circuit coupled to the data communications circuit, for verifying that a connection with the communication device has been established;
d. a notification circuit coupled to the data communications circuit and the verification circuit for informing a user of a status of connection between the personal digital assistant device and the communication device; and
e. a user interface coupled to the data communications circuit, the verification circuit, and the notification circuit for receiving commands and the data from the user.

15. The personal digital assistant device as claimed in claim 14 further comprising a display coupled to the user interface for viewing of data input, received and transmitted.

16. The personal digital assistant device as claimed in claim 14 further comprising a microprocessor coupled to the data communications circuit, the verification circuit, the notification circuit, and the user interface for execution of programmed instructions.

17. The personal digital assistant device as claimed in claim 14 further comprising a data storage medium coupled to a microprocessor and the data communications circuit for storing received data.

18. The personal digital assistant device as claimed in claim 14 wherein the data communications circuit transfers data via an infra-red connection.

19. The personal digital assistant device as claimed in claim 14 wherein the data communications circuit transfers data via a wired connection.

20. The personal digital assistant device as claimed in claim 14 wherein the data communications circuit transfers data via a wireless connection.

21. A communication device comprising:
a. a microprocessor configured to execute programmed instructions;
b. a dialing device coupled to the microprocessor to automatically dial a telephone number;
c. a data receiving circuit coupled to the microprocessor and to the dialing device for receiving data from a personal digital assistant device; and
d. a first data transmitting circuit coupled to the microprocessor for transmitting data, and status and error messages to the personal digital assistant device.

22. The communication device as claimed in claim 21 wherein the dialing device is integrated within the communication device.

23. The communication device as claimed in claim 21 further comprising a user interface coupled to the microprocessor and the dialing device for inputting telephone numbers to be dialed by the dialing device.

24. The communication device as claimed in claim 21 further comprising a data storage medium coupled to the microprocessor, the dialing device and the data receiving circuit for storing received data.

25. The communication device as claimed in claim 21 further comprising a data analyzing circuit coupled to a microprocessor and to the data receiving circuit for analyzing received data from an external source to determine whether the received data will permit a call to be placed.

26. The communication device as claimed in claim 21 further comprising a dialing mechanism coupled to a microprocessor for simulating unique touch-pad dial-tones and triggering a dial-tone, and dialing a telephone number.

27. The communication device as claimed in claim 21 wherein the data receiving circuit includes an infra-red connection.

28. The communication device as claimed in claim 21 wherein the first data transmitting circuit includes a wired connection.

29. The communication device as claimed in claim 21 wherein the data receiving circuit and the first data transmitting circuit include a wireless connection.

30. The communication device as claimed in claim 21 wherein the communication device is a telephone.

31. The communication device as claimed in claim 21 wherein the communication device is a wireless telephone.

32. The communication device as claimed in claim 21 wherein the communication device is a two-way pager.

33. The communication device as claimed in claim 21 wherein the communication device is a video phone.

34. A dialing device comprising:
a. a microprocessor configured to execute programmed instructions;
b. a data receiving circuit coupled to the microprocessor for receiving data from a communication device;
c. a dialing mechanism coupled to the microprocessor and the data receiving circuit for simulating unique touch-pad dial-tones and triggering a dial-tone at the communication device; and
d. a data transmitting circuit coupled to the microprocessor for transmitting data, and status and error messages to the communication device.

35. The dialing device as claimed in claim 34 further comprising a data storage medium coupled to the microprocessor, the dialing mechanism and the data receiving circuit for storing received data.

36. The dialing device as claimed in claim 34 further comprising a display coupled to the microprocessor for viewing of data input, received and transmitted.

37. The dialing device as claimed in claim 34 further comprising a verification circuit coupled to the data receiving circuit and the microprocessor for verifying whether a connection with a communication device has been established.

38. The dialing device as claimed in claim 34 further comprising a data analyzing circuit coupled to the data receiving circuit and the microprocessor for analyzing received data from an external source to determine whether the received data will permit a call to be placed.

39. The dialing device as claimed in claim 34 further comprising a second data receiving circuit coupled to the microprocessor for receiving data from an external source.

40. The dialing device as claimed in claim 34 wherein the data receiving circuit includes an infra-red connection.

41. The dialing device as claimed in claim 34 wherein the data transmitting circuit includes a wired connection.

42. The dialing device as claimed in claim 34 wherein the data receiving circuit and data transmitting circuit include a wireless connection.
